(19) United States
(12) Patent Application Publication
(10) Pub. No.: US 2006/0145628 A1
(43) Pub. Date: Jul. 6, 2006

(54) Driving assembly for high-power gas discharge lamps

(75) Inventor: Dolf Henricus Jozef Van Casteren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/562,889

(22) PCT Filed: Jun. 30, 2004
(86) PCT No.: PCT/IB04/51068

§ 371 Date: Dec. 29, 2005

(30) Foreign Application Priority Data
Jul. 4, 2003 (EP) 03102007.6

(51) Int. Cl. H05B 39/04

(52) U.S. Cl. 315/209 R

(57) ABSTRACT

A driver assembly (10) for driving a high-power gas discharge lamp (L) comprises a plurality of at least two low-power lamp drivers (1A, 1B, 1C) having their respective output terminals coupled in parallel, each individual driver (1A, 1B, 1C) being designed for generating a commutating DC-current at its respective output terminal, the assembly (10) comprising synchronisation means for synchronising the output currents of the individual drivers (1A, 1B, 1C).

### FIELD OF THE INVENTION

The present invention relates in general to the field of drivers for gas discharge lamps, more specifically high-intensity discharge (HID) lamps.

### BACKGROUND OF THE INVENTION

Conventionally, gas discharge lamps are driven by CuFe ballasts. Also, electronic drivers have been developed, which offer advantages such as higher operational frequency and improved efficiency.

Gas discharge lamps are designed for a specific nominal power, and drivers for such lamps need to be designed for the required power specification. Up till now, electronic drivers for gas discharge lamps having nominal power of, for instance, 50 W, 150 W, 250 W, 400 W, 600 W are available. Gas discharge lamps having very high power, for instance 1800 W, are nowadays still driven by CuFe ballasts. However, it is desirable that these lamps are also driven by electronic drivers. Thus, there is a need for high-power electronic drivers for gas discharge lamps, specifically HID lamps.

Although low-power or medium-power electronic drivers for gas discharge lamps have been developed, it is not easily possible to develop a high-power electronic driver. For instance, it is not simply possible to scale-up existing designs. A high-power electronic driver should be developed from the basic drawing board, which takes a lot of time and is quite costly. Further, components to be used for such high-power electronic driver involve high-power components, which are expensive.

### SUMMARY OF THE INVENTION

An objective of the present invention is to provide an electronic driver apparatus for high-power gas discharge lamps. According to an important aspect of the present invention, an electronic driver apparatus is designed as an electronic driver assembly comprising a plurality of low-power electronic drivers connected in parallel. Thus, the present invention advantageously uses existing low-power electronic drivers, which are relatively low-cost since they are manufactured in large volumes. Further, development of low-power electronic drivers has advanced very far already, so that these components are very reliable.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1A is a block diagram schematically showing the general two-stage design of a prior art gas discharge lamp driver;

FIG. 1B is a graph schematically illustrating the shape of the current through a gas discharge lamp;

FIG. 2 is a block diagram schematically showing the general design of a driver assembly in accordance with the present invention;

FIG. 3 is a block diagram comparable to FIG. 2, schematically showing a specific embodiment of a driver assembly in accordance with the present invention;

FIG. 4A is a block diagram schematically illustrating relevant components of a forward commutator;

FIGS. 4B-D are block diagrams schematically illustrating synchronisation details of specific embodiments of a driver assembly in accordance with the present invention;

FIGS. 5A-D are block diagrams schematically illustrating safety control details of specific embodiments of a driver assembly in accordance with the present invention;

FIG. 6 is a block diagram illustrating a variation of the embodiment of FIG. 4D.

### DESCRIPTION OF THE INVENTION

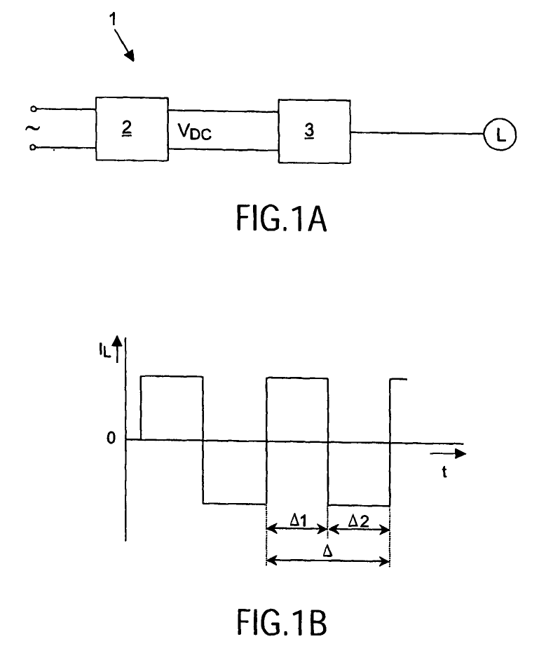

FIG. 1A is a block diagram schematically showing the general two-stage design of a prior art gas discharge lamp driver 1 for a lamp L. Such driver 1 comprises a first stage 2, also indicated as pre-conditioner, having an input for receiving AC mains voltage, typically in the order of about 230 V. The pre-conditioner comprises rectifying means for rectifying the input voltage, and up-transformer means for transforming the rectified voltage up to a DC voltage, typically in the order of 400 V or higher.

A second stage 3 has an input receiving the DC voltage from the pre-conditioner, and has an output connected to the lamp L. This second stage, also indicated as forward commutator, is designed for generating an alternating DC current at its output, i.e. a current having substantially constant magnitude but alternating direction. FIG. 1B schematically illustrates the shape of the current I_{L} through the lamp L as a function of time t; herein, any superimposed high-frequency ripple components are neglected. During a first commutation interval Δ1, the lamp current flows into one direction, whereas in a second commutation interval Δ2 the lamp current has the same magnitude but flows in the opposite direction. The overall commutation period is indicated as Δ=Δ1+Δ2.

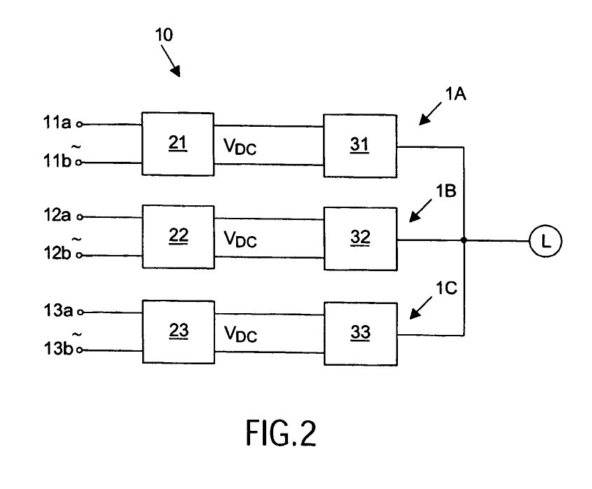

FIG. 2 is a block diagram schematically showing the general design of a driver assembly 10, which comprises three drivers 1A, 1B, 1C of conventional design, having their outputs connected together to feed a high-power lamp L (for instance 1800 W). Each driver 1A; 1B; 1C comprises a pre-conditioner 21; 22; 23 and a forward commutator 31; 32; 33, respectively. Since the current through the high-power lamp L is provided by three drivers, each of the three pre-conditioners and each of the three forward commutators may be of a low-power design (for instance 600 W).

The first driver 1A has input terminals 11a and 11b. The second driver 1B has input terminals 12a and 12b. The third driver 1C has input terminals 13a and 13b. In a first variation, the three drivers are fed from the same mains, for instance 230 V one-phase mains, so that terminals 11a, 12a, 13a are connected together and terminals 11b, 12b, 13b are connected together. An advantage of this variation is that the assembly 10 can be powered from common one-phase mains. It is also possible that terminals 11a, 12a, 13a are connected to one phase of a three-phase mains, and that terminals 11b, 12b, 13b are connected to another phase of this three-phase mains; an advantage is that the voltage available between two phases of a three-phase mains is higher than the voltage available between one phase and neutral.

In a second variation, the three drivers are fed from the three phases of a three-phase mains. In the following, the three phases of a three-phase mains will be indicated as P1, P2, P3, respectively, while the neutral conductor will be indicated as N. In one implementation, the drivers are always connected between one phase and neutral (star configuration); for instance, terminals 11a, 12a, 13a are connected to phases P1, P2, P3, respectively, whereas terminals 11b, 12b, 13b are connected to N. In another implementation, the drivers are always connected between two subsequent phases (triangle configuration); for instance, terminals 11a, 12a, 13a are connected to phases P1, P2, P3, respectively, whereas terminals 11b, 12b, 13b are connected to phases P2, P3, P1, respectively.

Using more than one phase has the advantage of increased reliability. If one of the phases fails, the system can continue operating at a lower power level. The star configuration has the advantage that the mains current is sinusoidal and that, during normal operation, the neutral line carries no current. The triangle configuration has the advantage that the resulting pre-conditioner output voltage is substantially higher, which makes this implementation specifically suitable to operate high voltage burners.

It is to be noted, however, that the present invention is not limited to an assembly design comprising three drivers. A driver assembly in accordance with the present invention may have two, or four or more drivers connected in parallel. In the case of the first variation, all pre-conditioner inputs are connected in parallel. In the case of the second variation, it is preferred that the number of drivers can be written as 3·N, wherein N is an integer, and that always N pre-conditioner inputs are connected in parallel.

In the simplest implementation, the individual drivers 1A, 1B, 1C, . . . are operating autonomously, i.e. independent from each other. However, since such independent operation may lead to problems and even failure, such is not preferred. Preferably, there is some operative coupling between the individual drivers 1A, 1B, 1C, This operative coupling may relate to one or more of the following aspects:
ignition
synchronisation
distribution of power
safety
   as will be explained in more detail.
   Ignition

As is known to persons skilled in the art, drivers 1A, 1B, 1C, . . . are normally provided with a built-in ignitor device (not shown in FIG. 2) which is capable of providing high voltage pulses to the driver output during an initial stage of lamp operation, when the lamp is OFF and needs to be ignited. In an embodiment where the individual drivers are provided with a built-in ignitor device, steps may be taken to ensure that the individual ignitors do not disturb each other.

In one possibility, only one ignitor of only one of said individual drivers is active, while all other ignitors are made inactive. One problem of this solution is, however, that now one single ignitor needs to be capable of handling the overall current of the entire driver assembly circuit.

In another possibility, individual ignitor devices are disconnected, and their outputs are connected together, such that these ignitor device together define one large ignitor.

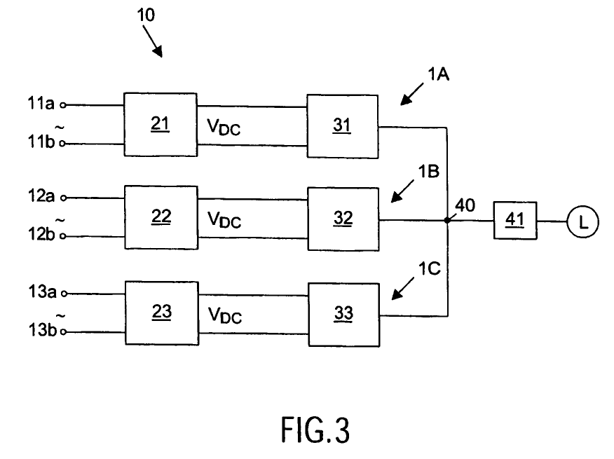

In a preferred embodiment, the individual drivers 1A, 1B, 1C, . . . are designed without individual ignitors, i.e. they are ignitorless drivers, and the driver assembly 10 is provided with a common ignitor 41 between the lamp L and the output node 40 of the forward commutator stages 31, 32, 33 . . . , as illustrated in FIG. 3. An advantage of such embodiment is that the ignitor can be accomodated in the lamp housing, which implies that any wiring between ignitor 41 and lamp L can be relatively short. Since the ignitor 41 can be a standard ignitor, it is not necessary here to explain the design and operation of the ignitor 41 in more detail.

Synchronisation

The individual pre-conditioners need not be mutually synchronised, mainly because, at least under normal circumstances, their output is a constant output voltage, wherein internal timings within the individual pre-conditioners do not play any role of importance. In contrast, the individual forward commutator stages 31, 32, 33 provide individual AC current contributions to the overall lamp current, each of such individual AC current contributions being characterised by the current curve of FIG. 1B. If each individual forward commutator stage operates totally independent from all others, it is very difficult to ensure that all such individual AC current contributions are completely in phase with each other. Being “completely in phase” means that all commutator stages 31, 32, 33 must operate at exactly the same frequency (=1/Δ) and must switch from positive to negative current and vice versa at exactly the same moment. In case a phase shift is present between any two of said stages, this creates a low-resistance path between a high-voltage line and a low-voltage line, resulting in very high currents which are only limited by current limiting protection means coming into action.

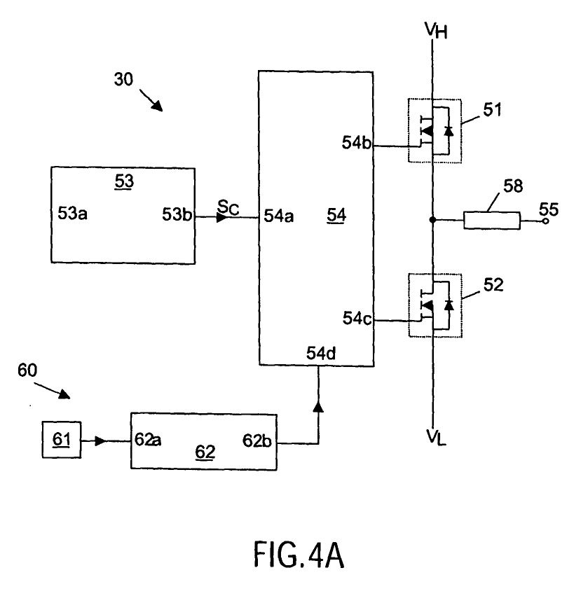

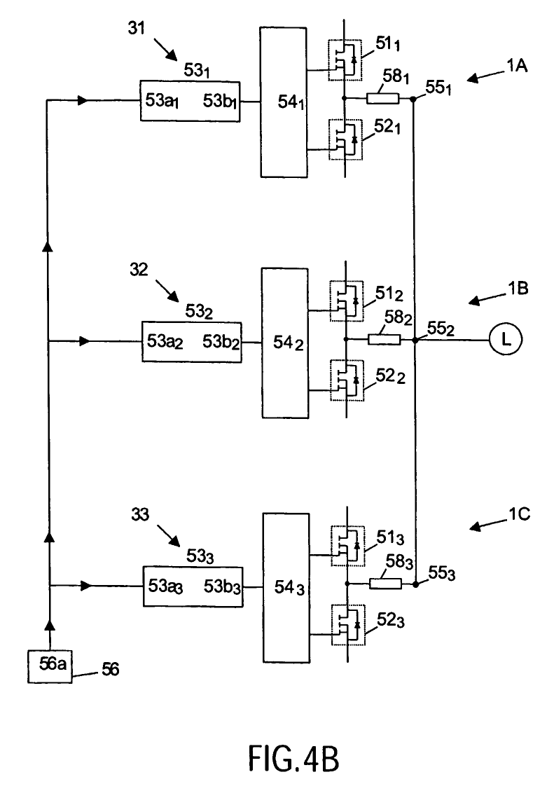

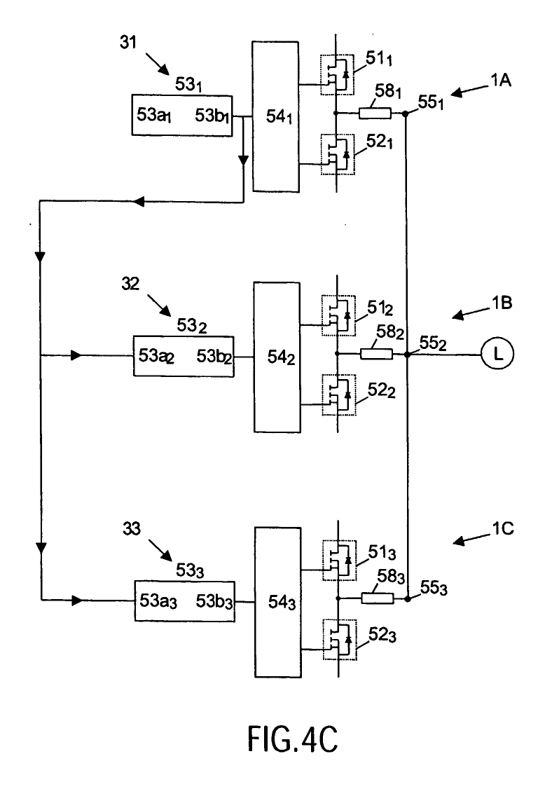

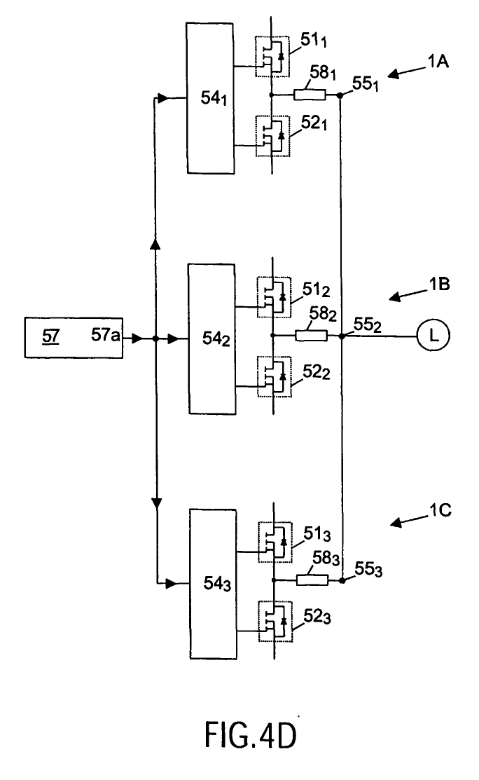

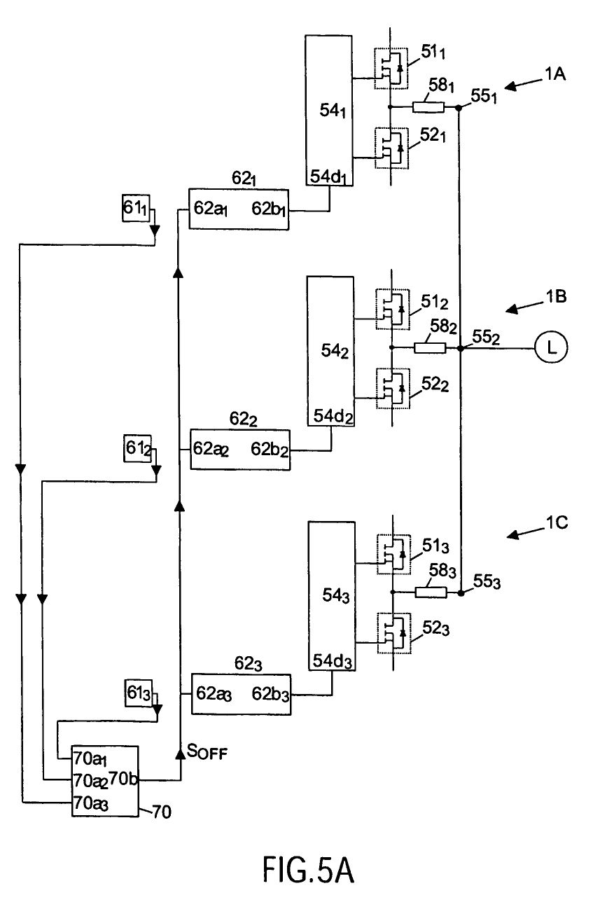

FIG. 4A is a block diagram schematically illustrating some relevant components of a possible embodiment of a forward commutator 30 which can be used to implement the commutator stages 31, 32, 33. Such forward commutator 30 comprises two controllable switches 51, 52, connected in series between a high voltage level supply line V_{H} and a low voltage level supply line V_{L}, typically the output of a pre-conditioner. The node between these two switches, typically implemented as MOSFETs, is coupled to a lamp output terminal 55 via an output filter 58, which comprises an inductor (not shown) in series with the output and a capacitor (not shown) parallel to the output, as will be known to persons skilled in the art. A switch driver 54 has outputs 54b and 54c, respectively, connected to control terminals of said switches.

For driving the switches, the switch driver 54 can operate in several possible modes. Hereinafter, one possible mode of operation will be explained by way of example only. In this one mode of operation, the switch driver 54 is either in a first operative state or in a second operative state. In the first operative state, the switch driver 54 generates its output signals such that second switch 52 is continuously non-conductive while first switch 51 is switched from its conductive state to its non-conductive state at a relatively high frequency, in which case current flows from high voltage level supply line V_{H} via output filter 58 into lamp output terminal 55. In the second operative state, the switch driver 54 generates its output signals such that first switch 51 is continuously non-conductive while second switch 52 is switched from its conductive state to its non-conductive state at a relatively high frequency, in which case current flows from lamp output terminal 55 via output filter 58 to low voltage level supply line V_{L}. The switch driver also has an OFF state, in which both switches 51 and 52 are continuously non-conductive. The switch driver 54 in turn has a control input 54a coupled to a control output 53b of a timing controller 53, which generates a control signal S_{c} for the switch driver 54, the control signal S_{c} having two signal values causing the switch driver 54 to operate in either its first operative state or in its second operative state, respectively. The timing of this control signal S_{c} determines the timing of the positive and negative commutation periods of the output current.

FIGS. 4B-D illustrate various embodiments in which synchronisation is implemented. In these Figures, individual switches 51, 52, switch drivers 54, and timing controllers 53 of the three commutators 31, 32, 33 are shown, distinguished by indexes 1, 2, 3, respectively.

In the embodiment of FIG. 4B, each timing controller 53 has a control input 53a. The driver assembly 10 in this embodiment is provided with a common clock signal generator 56, which has an output 56a connected to all timing controller inputs 53a₂, 53a₂, 53a₃. Thus, the timing controllers 53₁, 53₂, 53₃ have the same time base and control the switching of their respective switch drivers 54₁, 54₂, 54₃ at exactly the same moment.

In the embodiment of FIG. 4C, the first timing controller 53₁ has the status of master, and has its output 53b₁ connected to all other timing controller inputs 53a₂, 53a₃. Thus, a separate clock signal generator 56 is avoided; the role of the separate clock signal generator 56 is played by the first timing controller 53₁. Again, the timing controllers 53₁, 53₂, 53₃ have the same time base and control the switching of their respective switch drivers 54₁, 54₂, 54₃ at exactly the same moment.

In the embodiment of FIG. 4D, the individual timing controllers 53₁, 53₂, 53₃ are replaced by one single common timing controller 57, which has an output 57a connected to the control inputs 54a₁, 54a₂, 54a₃ of the respective switch drivers 54₁, 54₂, 54₃.

An advantage of the embodiment of FIG. 4D is that the total number of components is reduced. An advantage of the embodiment of FIG. 4C is that no additional components are required. The advantages of the embodiments of FIGS. 4C and 4D can be combined if said one single common timing controller 57 is implemented by the first timing controller 531 of the first commutator 31.

An advantage of the embodiments of FIGS. 4B and 4D is that a modular design in which all individual commutators 31, 32, 33 are mutually identical is easily implemented. In such modular design, any one individual driver 1A, 1B, 1C may be added or taken away without disturbing operation of the driver assembly 10 as a whole (apart from the fact, of course, that the overall output current is provided by one driver more or less).

Distribution of Power

Ideally, each individual driver 1A, 1B, 1C provides the same current magnitude. If manufacturing tolerances are such that one or more drivers provide substantially less than nominal power, one or more of the other drivers need to provide substantially more than their nominal power in order to meet the demand of the lamp L. However, in well-designed drivers which are well-set, mutual deviations in current magnitude are not severe, and control measures are not needed in this respect.

Safety

Typically, a driver for a gas discharge lamp is provided with safety control circuitry, which monitors one or more operational parameters of the driver, and which is capable of switching OFF such driver in case it finds that anomalies exist. Typical operational parameters which are monitored are, for example, temperature and current magnitude. For instance, the driver is switched OFF if the current magnitude is so high that a short circuit must be present, or if the temperature of the driver rises beyond a safety level. Also, if the driver does not generate current at all, it is decided that something is wrong and the driver is switched OFF.

Such switching OFF is intended to prevent (further) damage to the driver. However, in a driver assembly comprising two or more driver units, switching OFF one driver unit may be very disadvantageous to one or more of the other driver units, because now these other driver units need to generate more current than nominal current. Typically, driver units are provided with protection means for limiting the output current to a certain maximum. Depending on the total number of driver units, the drivers may be caused to generate their maximum output current, and the overall current as received by the lamp may be less than nominal lamp current, which may lead to failure of the lamp.

According to the present invention, this problem is solved by designing safety control circuitry for drivers in a driver assembly such that all drivers are automatically switched OFF if the safety control circuitry decides that even one individual driver should be switched OFF.

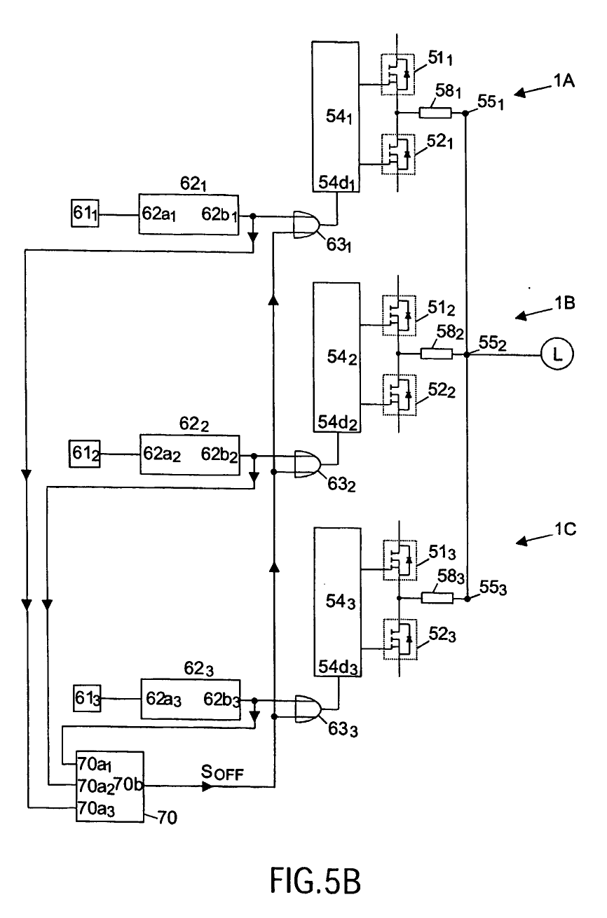

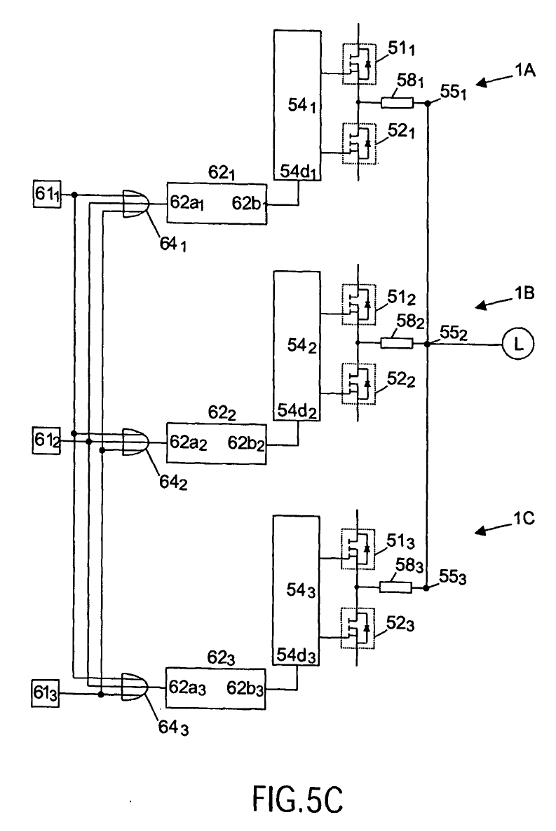

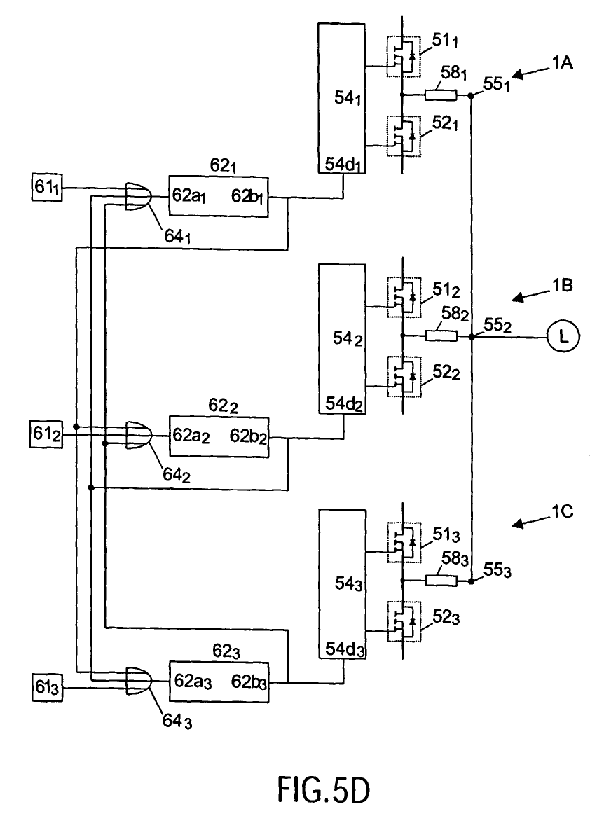

Several configurations are possible, which will be explained in the following with reference to FIGS. 4A and 5A-D. By way of example, the parameter “temperature” will be discussed, but it should be clear that the same discussion applies, mutatis mutandis, to other parameters like current magnitude etc.

FIG. 4A illustrates that the forward commutator 30 comprises safety control circuitry 60 including an individual temperature sensor 61 and an individual safety controller 62, which receives at an input 62a an output signal of said individual temperature sensor 61, and which has an output 62b coupled to a safety control input 54d of the corresponding switch driver 54. This individual safety controller 62 is designed to switch OFF the corresponding switch driver 54 if the temperature signal indicates a temperature above a predetermined level, by sending a control signal to the switch driver 54 which, in response, enters an OFF state in which it generates the switch control signals at its outputs 54b and 54c such that both switches 51 and 52 are in their non-conductive state.

In a case where all forward commutators 31, 32, 33 would have such individual safety control circuitry including an individual temperature sensor and an individual safety controller, and where all individual safety controllers would be operating independently, the above-mentioned disadvantages would arise.

FIG. 5A illustrates a first configuration wherein those disadvantages are avoided. The driver assembly 10 is provided with an additional main safety controller 70, which has inputs 70a₁, 70a₂, 70a₃ coupled to the individual temperature sensors 61₁, 61₂, 61₃, and which has an output 70b for generating an overall SWITCH-OFF signal S_{OFF}. The main safety controller 70 is designed to generate its overall SWITCH-OFF signal S_{OFF} if at least one of the signals received at its inputs indicates a temperature above said predetermined level.

Thus, in the configuration of FIG. 5A, the main safety controller 70 in fact checks all individual temperatures. If the temperature were the only parameter to consider, this would be reasonable, but if there are more parameters to consider, the number of input signals to this main safety controller 70 would be quite high. Therefore, in a preferred configuration, illustrated in FIG. 5B, the main safety controller 70 has inputs 70a₁, 70a₂, 70a₃ coupled to the control outputs 62b₁, 62b₂, 62b₃ of each individual safety controller 62₁, 62₂, 62₃, respectively, and the main safety controller 70 is designed to generate its overall SWITCH-OFF signal S_{OFF} if at least one of the signals received at its inputs 70a₁, 70a₂, 70a₃ indicates that the corresponding individual safety controller 62₁, 62₂, 62₃ has generated its individual SWITCH-OFF signal. Thus, in this case, the main safety controller in fact checks all individual safety controllers, and decides to switch off the entire assembly 10 if even one individual safety controller 62₁, 62₂, 62₃ has found a parameter leading to a switch-off decision, whichever that parameter may be.

The overall SWITCH-OFF signal S_{OFF} of the main safety controller 70 may be sent to corresponding inputs 62a₁, 62a₂, 62a₃ of the individual safety controllers 62₁, 62₂, 62₃, which are designed, in response to receiving the overall SWITCH-OFF signal S_{OFF}, to generate their individual SWITCH-OFF signals for the corresponding switch drivers 54₁, 54₂, 54₃, as also illustrated in FIG. 5A. Preferably, however, the overall SWITCH-OFF signal S_{OFF} of the main safety controller 70 is sent directly to the safety control inputs 54d₁, 54d₂, 54d₃ of the individual switch drivers 54₁, 54₂, 54₃, which are designed to switch to their OFF state, i.e. to switch both corresponding switches 51 and 52 to their non-conductive state, in response to receiving either the individual SWITCH-OFF signal from the corresponding individual safety controller 62₁, 62₂, 62₃ or the overall SWITCH-OFF signal S_{OFF} from the main safety controller 70. FIG. 5B also illustrates this functionality for an embodiment where the switch drivers 54₁, 54₂, 54₃ are provided with corresponding OR-gates 63₁, 63₂, 63₃, each having an input receiving the individual SWITCH-OFF signal from the corresponding individual safety controller 62₁, 62₂, 62₃ and further having an input receiving the overall SWITCH-OFF signal S_{OFF} from the main safety controller 70, and each having an output coupled to the safety control inputs 54d₁, 54d₂, 54d₃ of the corresponding switch drivers 54₁, 54₂, 54₃.

It is noted that the OR-gates 63₁, 63₂, 63₃ may be omitted, and that the safety control inputs 54d₁, 54d₂, 54d₃ of the switch drivers 54₁, 54₂, 54₃ may only receive the overall SWITCH-OFF signal S_{OFF} from the main safety controller 70, in which case the safety control of the assembly 10 is performed solely by the single main safety controller 70. In this case, also the individual safety controllers may be omitted.

It is further noted that, as an alternative to the embodiment of FIG. 5A, each individual safety controller 62₁, 62₂, 62₃ may be provided with an OR-gate at its input to also receive the sensor output signal from the corresponding temperature sensor 61₁, 61₂, 61₃, respectively. Or, as an alternative to the embodiment of FIG. 5A, the main safety controller 70 may receive its input signals from the nodes 61/62.

In another embodiment, illustrated in FIG. 5C, an additional main safety controller is avoided. In this embodiment, each individual safety controller 62₁, 62₂, 62₃ is provided with an OR-gate 64₁, 64₂, 64₃, respectively, each OR-gate 64₁, 64₂, 64₃ having inputs for receiving all sensor signals from all corresponding temperature sensor 61₁, 61₂, 61₃. In still another embodiment, illustrated in FIG. 5D, each OR-gate 64₁; 64₂; 64₃ associated with an individual safety controller 62₁; 62₂; 62₃, respectively, has its inputs connected to the outputs of all other individual safety controller 62₂, 62₃; 62₁, 62₃; 62₁, 62₂. Again, all switch drivers are set to their OFF state if only one sensor detects an anomaly.

It is noted that, from the above-discussed embodiments of FIGS. 5A-5C, the embodiment of FIG. 5B is preferred since it is easily implemented with only very few modifications to existing driver design.

It should be clear to a person skilled in the art that the present invention is not limited to the exemplary embodiments discussed above, but that various variations and modifications are possible within the protective scope of the invention as defined in the appending claims.

In the above, the present invention is explained for an exemplary embodiment wherein each individual driver has a two-stage design of pre-conditioner and forward commutator. However, instead of the individual drivers 1A, 1B, 1C having a two-stage design of pre-conditioner and forward commutator, it is also possible that the individual drivers have a three-stage design of pre-conditioner, down-converter and commutator.

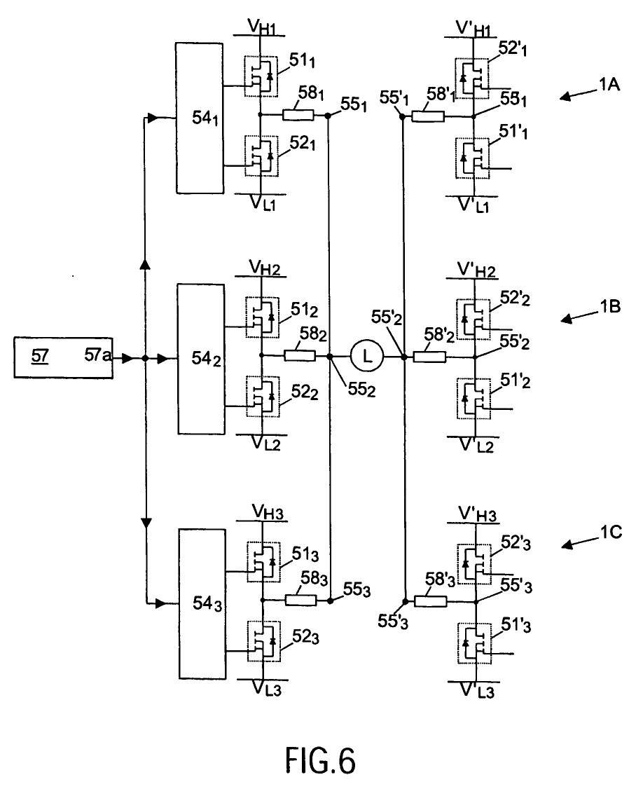

Further, in the above exemplary embodiment, the forward commutator is shown as a half-bridge embodiment (HBCF). The present invention can, however, also be implemented as a full-bridge embodiment (FBCF). This is illustrated specifically in FIG. 6, which shows a variation of the embodiment illustrated in FIG. 4D. In the full-bridge embodiment of FIG. 6, each driver 1A, 1B, 1C comprises four switches 51, 52, 52′, 51′, each of those switches being driven by the corresponding switch driver 54 such that the switches 51 and 51′ are opened and closed simultaneously, and that the switches 52 and 52′ are opened and closed simultaneously (the connection between switch control inputs and the corresponding driver outputs is not shown for sake of convenience). The switches 52′ and 51′ are connected in series between the high voltage supply line V_{H} and the low voltage supply line V_{L}. A node between these switches 52′ and 51′ is coupled to a second lamp output terminal 55′.

The same variation also applies to the embodiments of FIGS. 4B, 4C, 5A-D.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Driver assembly (10) for driving a gas discharge lamp (L), comprising a plurality of at least two lamp drivers (1A, 1B, 1C) having their respective output terminals coupled in parallel, each individual driver (1A, 1B, 1C) being designed for generating a commutating DC-current at its respective output terminal, the assembly (10) comprising synchronisation means for synchronising the output currents of the individual drivers (1A, 1B, 1C).

2. Driver assembly according to claim 1, wherein each individual driver (1A, 1B, 1C) comprises switching means comprising:
two controllable switches (51, 52) connected in series between a high voltage supply line (V_{H}) and a low voltage supply line (V_{L}), a node between said switches coupled to the said driver output terminal;
a switch driver (54) having outputs (54b, 54c) coupled to respective control terminals of the controllable switches (51, 52);
a timing controller (53) having an output (53b) for generating a timing control signal (S_{c}) coupled to a timing input (54a) of the corresponding switch driver (54);
wherein said synchronisation means are adapted for synchronising the timing control signals (S_{c}) of the individual timing controllers (53).

3. Driver assembly according to claim 2, wherein said synchronisation means comprise a clock signal generator (56) having an output (56a) for generating a clock signal coupled to inputs (53a₁, 53a₂, 53a₃) of all timing controllers (53₁, 53₂, 53₃).

4. Driver assembly according to claim 2, wherein the output (53b₁) of one timing controller (53₁) is coupled to inputs (53a₁, 53a₂, 53a₃) of all other timing controllers (53₂, 53₃).

5. Driver assembly according to claim 1, wherein each individual driver (1A, 1B, 1C) comprises switching means comprising:
two controllable switches (51, 52) connected in series between a high voltage supply line (V_{H}) and a low voltage supply line (V_{L}), a node between said switches coupled to the said driver output terminal;
a switch driver (54) having outputs (54b, 54c) coupled to respective control terminals of the controllable switches (51, 52); the assembly (10) further comprising a common timing controller (57) having an output (57b) for generating a timing control signal (S_{c}) coupled to timing inputs (54a₁, 54a₂, 54a₃) of all switch drivers (54₁, 54₂, 54₃).

6. Driver assembly (10) for driving a gas discharge lamp (L), comprising a plurality of at least two lamp drivers (1A, 1B, 1C) having their respective output terminals coupled in parallel, each individual driver (1A, 1B, 1C) being designed for generating a commutating DC-current at its respective output terminal, the assembly (10) comprising a common ignitor (41).

7. Driver assembly (10) for driving a gas discharge lamp (L), comprising a plurality of at least two lamp drivers (1A, 1B, 1C) having their respective output terminals coupled in parallel, each individual driver (1A, 1B, 1C) being designed for generating a commutating DC-current at its respective output terminal, each individual driver (1A, 1B, 1C) comprising individual ignitor means;
wherein only one of said individual ignitor means is actually coupled to the output terminal of the corresponding individual driver (1A, 1B, 1C).

8. Driver assembly (10) for driving a gas discharge lamp (L), comprising a plurality of at least two lamp drivers (1A, 1B, 1C) having their respective output terminals coupled in parallel, each individual driver (1A, 1B, 1C) being designed for generating a commutating DC-current at its respective output terminal, each individual driver (1A, 1B, 1C) comprising individual ignitor means;
the assembly (10) comprising synchronisation means for synchronising the operation of the individual ignitor means.

9. Driver assembly (10) for driving a gas discharge lamp (L), comprising a plurality of at least two lamp drivers (1A, 1B, 1C) having their respective output terminals coupled in parallel, each individual driver (1A, 1B, 1C) being designed for generating a commutating DC-current at its respective output terminal, each individual driver (1A, 1B, 1C) comprising individual ignitor means;
wherein the individual ignitor means are connected in parallel.

10. Driver assembly (10) for driving a gas discharge lamp (L), comprising a plurality of at least two lamp drivers (1A, 1B, 1C) having their respective output terminals coupled in parallel, each individual driver (1A, 1B, 1C) being designed for generating a commutating DC-current at its respective output terminal, the individual drivers (1A, 1B, 1C) being adapted to each other such as to mutually provide substantially the same amount of power.

11. Driver assembly (10) for driving a gas discharge lamp (L), comprising a plurality of at least two lamp drivers (1A, 1B, 1C) having their respective output terminals coupled in parallel, each individual driver (1A, 1B, 1C) being designed for generating a commutating DC-current at its respective output terminal;
wherein each individual driver (1A, 1B, 1C) comprises at least one sensor (61) for monitoring at least one operational parameter of the corresponding driver (1A, 1B, 1C);
wherein the assembly further comprises safety control circuitry adapted for switching off the entire assembly if at least one of said sensors detects an anomaly.

12. Driver assembly according to claim 11, further comprising a main safety controller (70) having inputs (70a₁, 70a₂, 70a₃) coupled to outputs of respective sensors (61₁, 61₂, 61₃), and having an output (70b) for generating an overall switch-off signal (S_{OFF})

13. Driver assembly according to claim 12, wherein each individual driver (1A, 1B, 1C) comprises switching means comprising:
two controllable switches (51, 52) connected in series between a high voltage supply line (V_{H}) and a low voltage supply line (V_{L}), a node between said switches coupled to the said driver output terminal;
a switch driver (54) having outputs (54b, 54c) coupled to respective control terminals of the controllable switches (51, 52), and further having a safety control input (54d);
wherein the output (70b) of the main safety controller (70) is coupled to safety control inputs (54d₁, 54d₃, 54d₃) of all individual switch drivers (54₁, 54₃, 54₃).

14. Driver assembly according to claim 12, wherein each individual driver (1A, 1B, 1C) comprises switching means comprising:
two controllable switches (51, 52) connected in series between a high voltage supply line (V_{H}) and a low voltage supply line (V_{L}), a node between said switches coupled to the said driver output terminal;
a switch driver (54) having outputs (54b, 54c) coupled to respective control terminals of the controllable switches (51, 52), and further having a safety control input (54d); each individual driver (1A, 1B, 1C) further comprising an individual safety controller (62₁, 62₂, 62₃) having an output (62b₁, 62b₂, 62b₃) coupled to a safety control input (54d₁, 54d₃, 54d₃) of the corresponding switch driver (54₁, 54₃, 54₃); wherein the output (70b) of the main safety controller (70) is coupled to inputs (62a₁, 62a₂, 62a₃) of all individual safety controllers (62₁, 62₂, 62₃).

15. Driver assembly according to claim 11; wherein each individual driver (1A, 1B, 1C) further comprises switching means comprising:
two controllable switches (51, 52) connected in series between a high voltage supply line (V_{H}) and a low voltage supply line (V_{L}), a node between said switches coupled to the said driver output terminal;
a switch driver (54) having outputs (54b, 54c) coupled to respective control terminals of the controllable switches (51, 52), and further having a safety control input (54d);
each individual driver (1A, 1B, 1C) further comprising an individual safety controller (62₁, 62₂, 62₃) having an input (62a₁, 62a₂, 62a₃) coupled to outputs of respective sensors (61₁, 61₂, 61₃); the assembly (10) further comprising a main safety controller (70) having inputs (70a₁, 70a₂, 70a₃) coupled to outputs (62b₁, 62b₂, 62b₃) of respective individual safety controllers (62₁, 62₂, 62₃), and having an output (70b) for generating an overall switch-off signal (S_{OFF}).

16. Driver assembly according to claim 15, wherein the output (70b) of the main safety controller (70) is coupled to safety control inputs (54d₁, 54d₃, 54d₃) of all individual switch drivers (54₁, 54₃, 54₃).

17. Driver assembly according to claim 15, wherein the output (70b) of the main safety controller (70) is coupled to inputs (62a₁, 62a₂, 62a₃) of all individual safety controllers (62₁, 62₂, 62₃).

18. Driver assembly according to claim 11, wherein each individual driver (1A, 1B, 1C) comprises switching means comprising:
two controllable switches (51, 52) connected in series between a high voltage supply line (V_{H}) and a low voltage supply line (V_{L}), a node between said switches coupled to the said driver output terminal;
a switch driver (54) having outputs (54b, 54c) coupled to respective control terminals of the controllable switches (51, 52), and further having a safety control input (54d);
each individual driver (1A, 1B, 1C) further comprising an individual safety controller (62₁, 62₂, 62₃) having an output (62b₁, 62b₂, 62b₃) coupled to the safety control input (54d₁, 54d₃, 54d₃) of the corresponding switch driver (54₁, 54₃, 54₃) and having an input (62a₁, 62a₂, 62a₃) coupled to the outputs of all sensors (61₁, 61₂, 61₃).

19. Driver assembly according to claim 11, wherein each individual driver (1A, 1B, 1C) comprises switching means comprising:
two controllable switches (51, 52) connected in series between a high voltage supply line (V_{H}) and a low voltage supply line (V_{L}), a node between said switches coupled to the said driver output terminal;
a switch driver (54) having outputs (54b, 54c) coupled to respective control terminals of the controllable switches (51, 52), and further having a safety control input (54d);
each individual driver (1A, 1B, 1C) further comprising an individual safety controller (62₁, 62₂, 62₃) having an output (62b₁, 62b₂, 62b₃) coupled to the safety control input (54d₁, 54d₃, 54d₃) of the corresponding switch driver (54₁, 54₃, 54₃);
each individual driver (1A, 1B, 1C) further comprising an OR-gate (64₁, 64₂, 64₃) having an output coupled to the input (62a₁, 62a₂, 62a₃) of the corresponding individual safety controller (62₁, 62₂, 62₃), having an input coupled to the output of the corresponding sensor (61₁, 61₂, 61₃) and having inputs coupled to the outputs of all other individual safety controllers (62₂, 62₃; 62₁, 62₃; 62₁, 62₂).

20. Driver assembly according to claim 1, each individual driver (1A, 1B, 1C) having power supply terminals (11a, 11b; 12a, 12b; 13a, 13b) for receiving AC mains power;
wherein all individual drivers (1A, 1B, 1C) have their power supply terminals (11a, 11b; 12a, 12b; 13a, 13b) connected in parallel for connection to one common AC mains power.

21. Driver assembly according to claim 1, each individual driver (1A, 1B, 1C) having power supply terminals (11a, 11b; 12a, 12b; 13a, 13b) for receiving AC mains power;
wherein the individual drivers (1A, 1B, 1C) are fed from a three-phase mains in a star configuration or a triangle configuration.

22. Driver assembly according to claim 21, wherein the number of individual driver (1A, 1B, 1C) equals 3-N, N being an integer;
wherein always N individual drivers (1A, 1B, 1C) have their power supply terminals (11a, 11b; 12a, 12b; 13a, 13b) connected in parallel for connection to one common phase of said three-phase mains power.

23. Driver assembly according to claim 1, wherein each individual driver comprises a preconditioner stage and a half-bridge commutating forward stage, or comprises a preconditioner stage and a full-bridge commutating forward stage, or comprises a preconditioner stage and a down-converter stage and a half-bridge commutating forward stage, or comprises a preconditioner stage and a down-converter stage and a full-bridge commutating forward stage.
